(19) United States
(12) Patent Application Publication
(10) Pub. No.: US 2016/0190759 A1
(43) Pub. Date: Jun. 30, 2016

(54) METHOD OF MANUFACTURING DOCK

(71) Applicant: SYNCMOLD ENTERPRISE CORP., New Taipei City (TW)

(72) Inventors: Kun-Tien TING, New Taipei City (TW); Chung-Cheng HU, New Taipei City (TW)

(21) Appl. No.: 14/674,506

(22) Filed: Mar. 31, 2015

(30) Foreign Application Priority Data
Dec. 31, 2014 (TW) 103146579

(51) Int. Cl. H01R 43/20; H01R 43/02

(52) U.S. Cl. CPC H01R 43/205; H01R 43/0235

(57) ABSTRACT

A method of manufacturing a dock is disclosed. The method includes the steps of extending a cable through a collar and a through hole of a housing, securing a strain relief sleeve on a cable, electrically connecting a circuit board to the cable, disposing the strain relief sleeve and the circuit board in a containing space defined by an inner surface of the housing, and then bonding a cover plate and the collar to the housing, respectively. By the manufacturing method of the present invention, it is easy and not time consuming to manufacture the dock, and can prevent any crack or detaching of the electrical joints between the cable and the circuit board caused by dragging or compressing the cable.

### CROSS REFERENCE TO RELATED APPLICATION

This application claims the benefits of the Taiwan Patent Application Serial Number 103146579, filed on Dec. 31, 2014, the subject matter of which is incorporated herein by reference.

### BACKGROUND OF THE INVENTION

1. Field of the Invention

The present invention relates to a method of manufacturing a dock, and more particularly to a method of manufacturing a dock having a strain relief sleeve.

2. Description of Related Art

In recent years, a dock including a connector and plural ports has been developed for connection with multiple peripheral devices to address the issue of most computer cases having insufficient built-in ports. As the circuit board of the dock can be provided with various processing modules (e.g. video processing modules, audio processing modules), the dock can further include video ports (e.g. HDMI ports, VGA ports), audio ports, or network ports in addition to USB ports for connection with USB interface-based electronic devices.

For physical retailers, information operation systems (e.g. Point of Sales, POS) have been used in businesses (such as retail shops or markets) to replace traditional cash registers owing to their various extended functions of recording and tracking customer orders, processing credit cards, connecting to other systems in a network, and managing inventory. In consideration of the extended functions, a dock is required by the POS system to provide ports for connection with I/O devices (e.g. keyboard, mouse, screen, printer etc.) and network connection with other external devices.

In the conventional art, the dock is usually manufactured by welding a cable to a circuit board and then assembling an upper housing and a lower housing by mortise-and-tenon connection or screw-in connection to install the cable and the circuit board in a containing space defined by the upper housing and the lower housing. However, a drawback arising from the conventional method is that the improper operation easily causes the cable to be dragged or compressed when manufacturing or using the dock. Undesirably, the dragging or compressing would impose stress on the solder joints between the cable and the circuit board, resulting in crack of the solder joints and degradation of electrical performance and reliability.

### SUMMARY OF THE INVENTION

The object of the present invention is to provide a method of manufacturing a dock, which includes steps of extending a cable through a collar and a through hole of a housing, securing a strain relief sleeve on the cable, electrically connecting a circuit board to the cable, disposing the circuit board and the strain relief sleeve in a containing space defined by an inner surface of the housing, and then bonding a cover plate and the collar to the housing. By the manufacturing method of the present invention, it is easy and not time consuming to manufacture the dock and can prevent the electrical joints between the cable and the circuit board from any crack or detaching caused by dragging or compressing the cable.

To achieve the object, the present invention provides a method of manufacturing a dock, including steps of: providing a cable that includes a first end and a second end opposite to the first end; disposing a collar on the cable; disposing a housing on the cable and between the collar and the first end of the cable, wherein the housing includes an inner surface, an outer surface, an opening and a second through hole, the inner surface defines a containing space, the opening and the second through hole extend through the inner surface and the outer surface and communicate with the containing space, respectively, and the cable extends through the second through hole; securing a strain relief sleeve on the cable and between the housing and the first end of the cable, wherein the strain relief sleeve includes a tube and a pad connected to each other, the pad has a third through hole and a dimension larger than the second through hole, and the cable extends through the third through hole; electrically connecting a circuit board to the first end of the cable; disposing the circuit board and the strain relief sleeve in the containing space through the opening of the housing; bonding a cover plate to the housing to seal the opening of the housing; and moving and bonding the collar to the housing.

The above or other advantages and features of the invention will become more apparent from the following detailed description when taken in conjunction with the accompanying drawings.

### BRIEF DESCRIPTION OF THE DRAWINGS

FIG. 1A is a perspective schematic view of a dock in accordance with the present invention;

FIG. 1B is a perspective schematic view of a dock at another angular orientation in accordance with the present invention;

FIG. 2 is an exploded perspective schematic view of a dock in accordance with the present invention;

FIG. 3 is a partial exploded perspective schematic view of a dock in accordance with the present invention;

FIG. 4 is a schematic view showing another aspect of a strain relief sleeve in accordance with the present invention;

FIG. 5 is a schematic view showing alternative aspects of a circuit board and a housing in accordance with the present invention;

FIG. 6 is a flow chart of manufacturing a dock in accordance with the present invention;

FIG. 7 is a perspective schematic view of a cable in accordance with an embodiment of the present invention;

FIG. 8 is a perspective schematic view showing a collar is disposed on the cable in accordance with an embodiment of the present invention;

FIG. 9 is a perspective schematic view showing a housing is disposed on the cable in accordance with an embodiment of the present invention;

FIG. 10 is a perspective schematic view showing a strain relief sleeve is disposed on the cable in accordance with an embodiment of the present invention;

FIG. 11 is a perspective schematic view showing the cable is electrically connected to a circuit board in accordance with an embodiment of the present invention;

FIG. 12 is a perspective schematic view showing the strain relief sleeve and the circuit board are disposed in a containing space in accordance with an embodiment of the present invention;

FIG. 13 is a perspective schematic view showing a cover plate is bonded to the housing in accordance with an embodiment of the present invention; and

FIG. 14 is a perspective schematic view showing the collar is bonded to the housing to finish the fabrication of a dock in accordance with an embodiment of the present invention.

### DETAILED DESCRIPTION OF THE PREFERRED EMBODIMENT

Hereafter, example will be provided to illustrate the embodiments of the present invention. Advantages and effects of the invention will become more apparent from the disclosure of the present invention. It should be noted that these accompanying figures are simplified and illustrative. The quantity, shape and size of components shown in the figures may be modified according to practical conditions, and the arrangement of components may be more complex. Other various aspects also may be practiced or applied in the invention, and various modifications and variations can be made without departing from the spirit of the invention based on various concepts and applications.

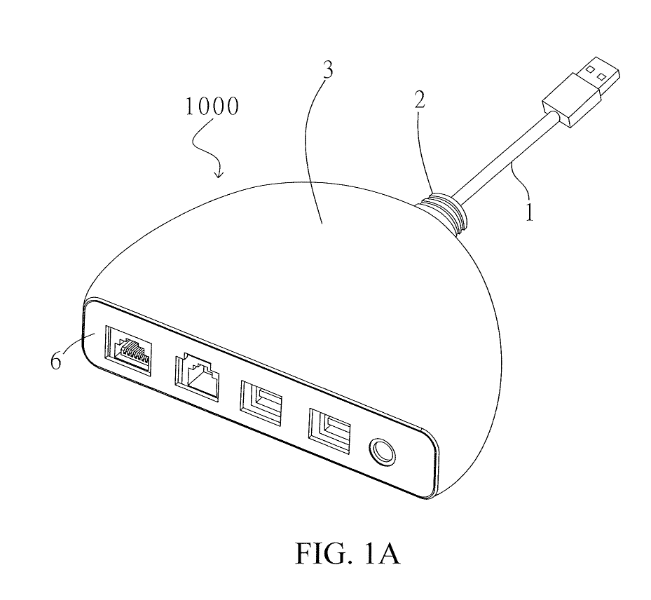

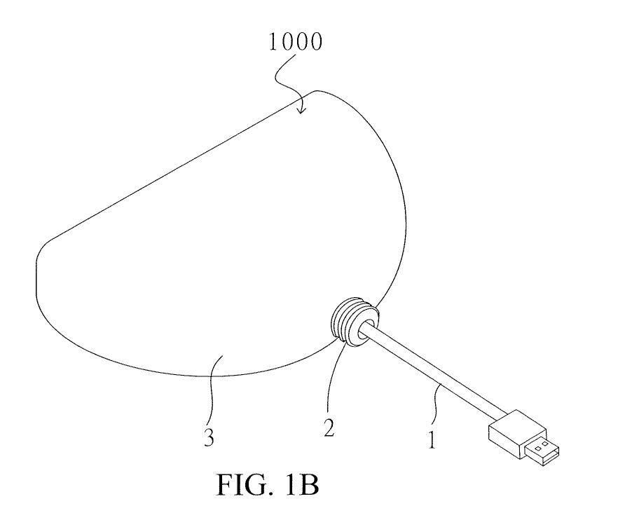

Please refer to FIGS. 1A, 1B and 2, in which FIGS. 1A and 1B are perspective schematic views of a dock 1000 at different angular orientations for illustration of its overall appearance, and FIG. 2 is its exploded perspective schematic view in accordance with the present invention. The dock 1000 includes a cable 1, a collar 2, a housing 3, a strain relief sleeve 4, a circuit board 5 and a cover plate 6. In this illustration, the strain relief sleeve 4 and the circuit board 5 are enclosed by the collar 2, the housing 3 and the cover plate 6.

As shown in FIGS. 1A and 2, the cable 1 has a first end 11 and a second end 12 opposite to the first end 11. The cable 1 includes one or more conducting wires 13 and a heat shrinkable sleeve 14 covering the conducting wires 13. The conducting wires 13 can be USB wires, HDMI wires or other various signal or power wires. The second end 12 of the cable 1 is provided with a connector 15 (such as USB connector) for electrical connection with a computer case (not shown in figures). For instance, the connector 15 may be electrically connected to a computer, a credit card reader or a point of sales (POS) system. Further, the first end 11 of the cable 1 is provided with two first terminal blocks 16 to be electrically connected to the circuit board 5.

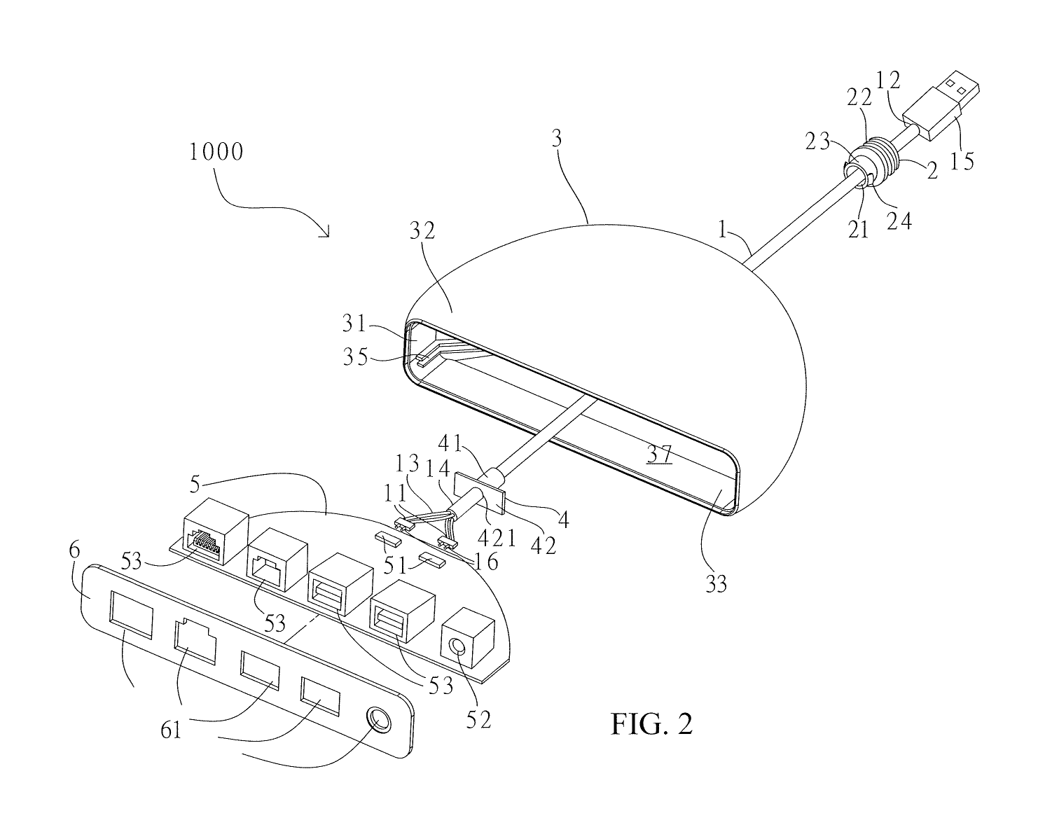

Attention is now directed to FIGS. 1B, 2 and 3 for detailed illustration of the collar 2, the housing 3 and the manner of assembling other components. FIG. 3 is a partial exploded perspective schematic view of the dock 1000 in accordance with the present invention. The collar 2 is disposed around the cable 1, and includes a first through hole 21, a first annular section 22, a second annular section 23, and two fitting structures 24 disposed on the peripheral edge of the second annular section 23. The first through hole 21 extends through the first annular section 22 and the second annular section 23. The first annular section 22 is connected with the second annular section 23, and has a larger cross-sectional dimension than that of the second annular section 23.

The housing 3 includes an inner surface 31, an outer surface 32, an opening 33, a second through hole 34, two guide rails 35 disposed on two opposite sides of the inner surface 31 (it is noted that FIG. 2 shows one guide rail 35 on one side only, due to angle limitation), and two guide grooves 36 formed at the peripheral edge of the second through hole 34. The inner surface 31 defines a containing space 37. The opening 33 and the second through hole 34 extend through the inner surface 31 and the outer surface 32, and communicate with the containing space 37 from two opposite sides, respectively. The fitting structures 24 of the collar 2 each have a cross-sectional shape corresponding to and consistent with the guide grooves 36 of the housing 3. In this embodiment, the fitting structures 24 and the guide grooves 36 each have a truncated fan shape in a cross section, but are not limited thereto. The first through hole 21 of the collar 2 and the second through hole 34 of the housing 3 each have a dimension consistent with the outer diameter of the cable 1 that extends through the first through hole 21 and the second through hole 34. The two lateral sides of the circuit board 5 are inserted into the two guide rails 35 of the housing 3, respectively, so as to avoid manufacturing difficulties caused by inclination of the circuit board 5. Preferably, the housing 3 is formed into an integrated structure by, for example, injection molding, but not limited thereto.

With regard to the assembly of the dock 1000, the following detailed description is provided for exemplary illustration. First, the collar 2 and the housing 3 are movably disposed around the cable 1. Then, the fitting structures 24 of the collar 2 are inserted into the guide grooves 36 of the housing 3. After the fitting structures 24 pass through the guide grooves 36, the collar 2 is screwed to tighten the second annular section 23 of the collar 2 in the second through opening 34. As a result, the collar 2 is bonded to the housing 3, and the second through hole 34 of the housing 3 is sealed. Preferably, the fitting structures 22 are configured into a barbed shape so as to fix the collar 2 to the housing 3 in a hooking manner. Further, the second through hole 34 of the housing 3 has a smaller transverse diameter in X axis than a longitudinal diameter in Y axis. Accordingly, the collar 2 can be tightly bonded to the housing 3 owing to the good packing effect induced by the screwing of the collar 2.

In this embodiment, there are illustrated two fitting structures 24 in the collar 2 and two guide grooves 36 in the housing 3. However, in other embodiments of the present invention, the bonding between the collar 2 and the housing 3 can also be achieved by one fitting structure in the collar and one guide groove in the housing. Therefore, the numbers of the fitting structures 24 and the guide grooves 36 are not limited.

Please refer to FIG. 2 for further illustration of the detailed structure of the strain relief sleeve 4 and the manner of assembling the strain relief sleeve 4 with other components. The strain relief sleeve 4 is secured to the cable 1, and can be formed around the peripheral edge of the cable 1 in close proximity to the first end 11 of the cable 1 by, but not limited to, molding. However, it should be noted that the collar 2 and the housing 3 should be first disposed around the cable 1 before the strain relief sleeve 4 is fixed to the cable 1 by molding. The strain relief sleeve 4 includes a tube 41 and a pad 42 connected to one end of the tube 41. The tube 41 surrounds the peripheral edge of the cable 1, and the pad 42 has a dimension larger than the second through hole 34 of the housing 3 and is located against the inner surface 31 of the housing 3. The pad 42 has a third through hole 421 to permit the cable 1 to extend through the tube 41 and the third through hole 421.

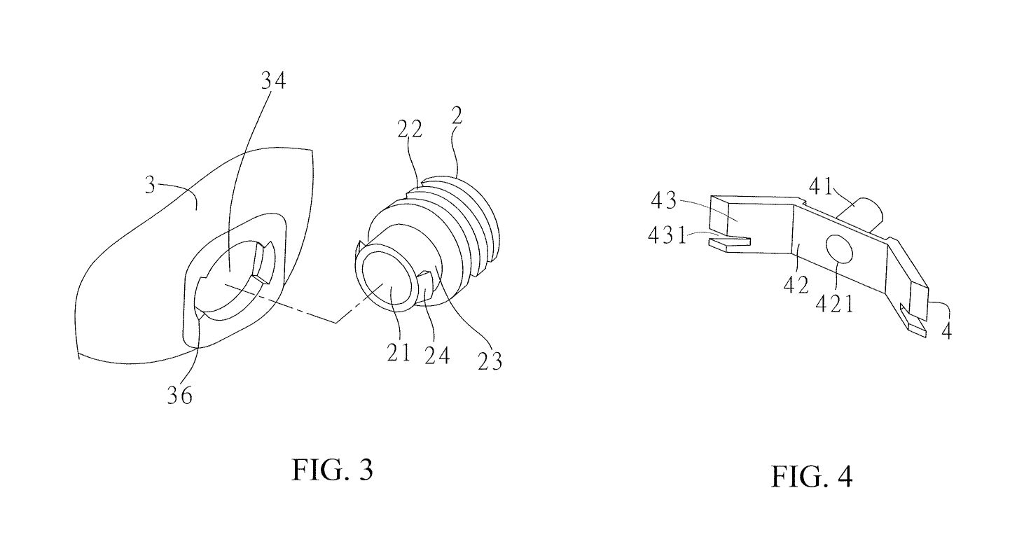

FIG. 4 shows another aspect of the strain relief sleeve 4 in accordance with the present invention. The strain relief sleeve 4 includes a tube 41, a pad 42 connected to one end of the tube 41, and two lateral flanges 43 respectively connected to two sides of the pad 42. In this illustration, the pad 42 has a third through hole 421, and the two lateral flanges 43 each have a groove 431. The circuit board 5 can be inserted into the grooves 431 and thus is fixed on the strain relief sleeve 4. Additionally, the grooves 431 are tapered from outside to inside for facilitating the insertion of the circuit board 5 thereinto.

Attention is now directed back to FIG. 2 for further illustration of the detail structure of the circuit board 5 and the manner of assembling the circuit board 5 with other components. The circuit board 5 is illustrated to include two second terminal blocks 51, a power socket 52 and four ports 53, but is not limited to the element quantity and type shown in the figure. The second terminal blocks 51 are used to electrically connect with the cable 1. Herein, the first terminal blocks 16 of the cable 1 and the second terminal blocks 51 of the circuit board 5 are complementary male and female terminals for plug-and-socket connection, respectively. The power socket 52 (such as DC power jack connector) is connected to an external DC power supplier to provide electrical power required for the dock 1000, whereas the ports 53 are coupled to various peripheral devices. For instance, the ports 53 may be USB ports, video ports (e.g. VGA ports, DVI ports or HDMI ports), audio ports, or network ports (e.g. RJ45/RJ11 ports). By virtue of the ports 53, the dock 1000 can be connected to an electronic device, a display device, a speaker device or a network. The two opposite lateral sides of the circuit board 5 are inserted in the guide rails 35 of the housing 3, and the circuit board 5 is pressed against the pad 42 of the strain relief sleeve 4.

The quantity of the first terminal blocks 16 and the second terminal blocks 51 can be modified according to requirement, and may be one set or three or more sets. It is also feasible to directly solder the conducting wires 13 at the first end 11 of the cable 1 to the circuit board 5 without the first terminal blocks 16 and the second terminal blocks 51.

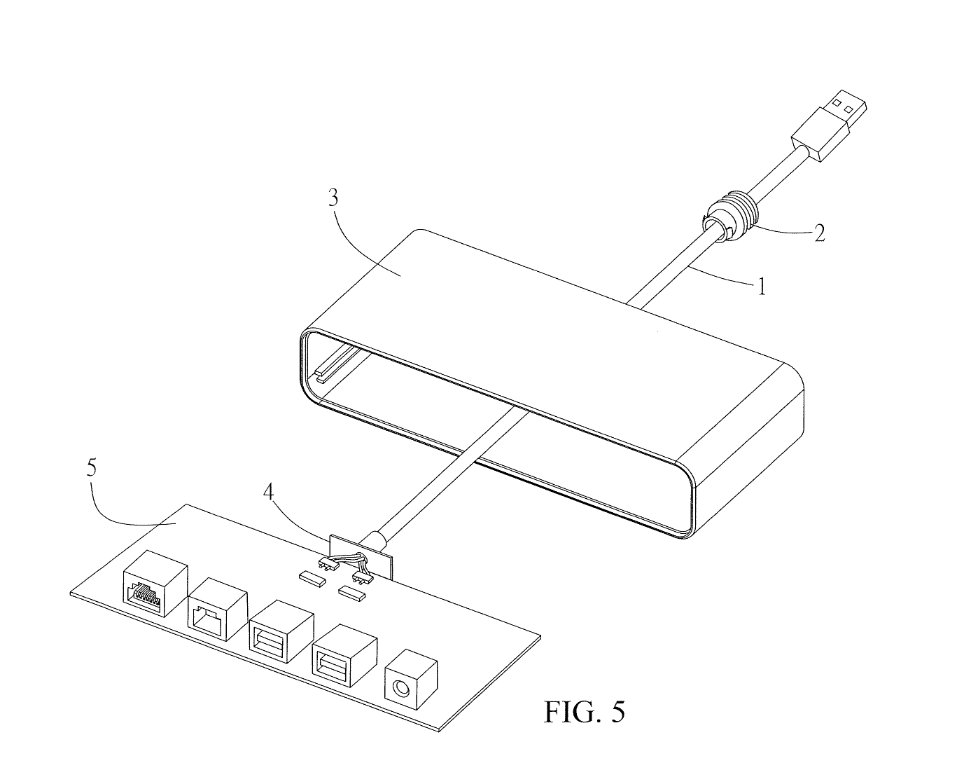

In accordance with this embodiment, as the second end 12 of the cable 1 is provided only with one connector 15, the housing 3 is shaped to have a containing space 37 with a decreasing cross-sectional area in the direction towards the second end 12 of the cable 1 to reduce the volume. Further, the plane shape of the circuit board 5 is also accordingly tapered in the direction towards the second end 12 of the cable 1 so as to smoothly dispose the circuit board 5 into the containing space 37. However, the shapes of the circuit board 5 and the housing 3 are not limited to those shown in FIG. 2. For instance, please referring to FIG. 5 for alternative aspects of the housing 3 and the circuit board 5 in accordance with the present invention, the housing 3 and the circuit board 5 can be configured to have rectangular parallelepiped appearance and rectangular plane shape, respectively. In this aspect, the containing space 37 has a constant cross-sectional area from the first end 11 to the second end 12 of the cable 1. As long as the lateral width of the circuit board 5 is smaller than the opening 33 to permit the lateral sides of the circuit board 5 to be inserted into the guide rails 35 of the housing 3, the rectangular circuit board 5 can be smoothly disposed in the containing space 37 with the pad 42 of the strain relief sleeve 4 being pressed against the inner surface 31 of the housing 3. In any case, the shapes of the housing 3 and the circuit board 5 are not limited.

Please referring to FIGS. 1A and 2, the detailed structure of the cover plate 6 and the manner of assembling the cover plate 6 with other components are specifically illustrated as follows. The cover plate 6 covers the opening 33 of the housing 3 and is bonded to housing 3 so as to seal the opening 33. By virtue of the cover plate 6, the housing 3 and the collar 2, the first end 11 of the cable 1, the strain relief sleeve 4 and the circuit board 5 are enclosed in the containing space 37. The bonding between the cover plate 6 and the housing 3 can be achieved by ultrasonic welding, but is not limited thereto. The cover plate 6 has a plurality of apertures 61 to expose the power socket 52 and the ports 53 of the circuit board 5 for connection with an external device, network and power supplier.

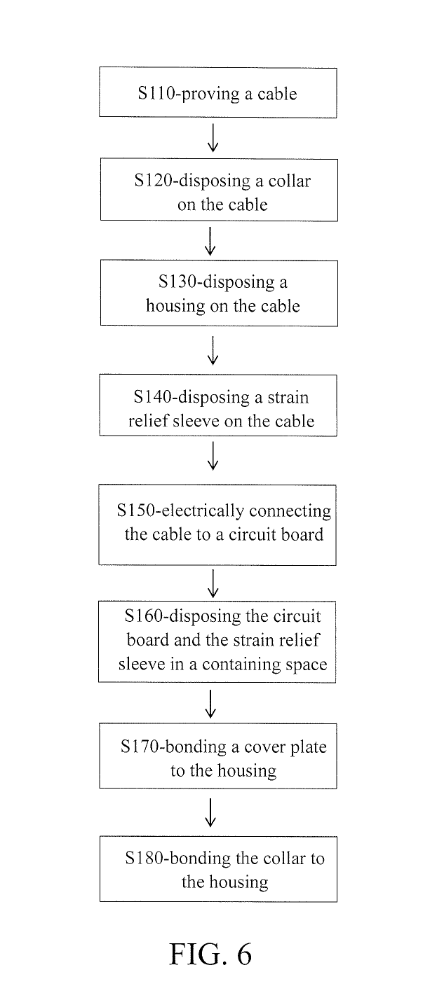

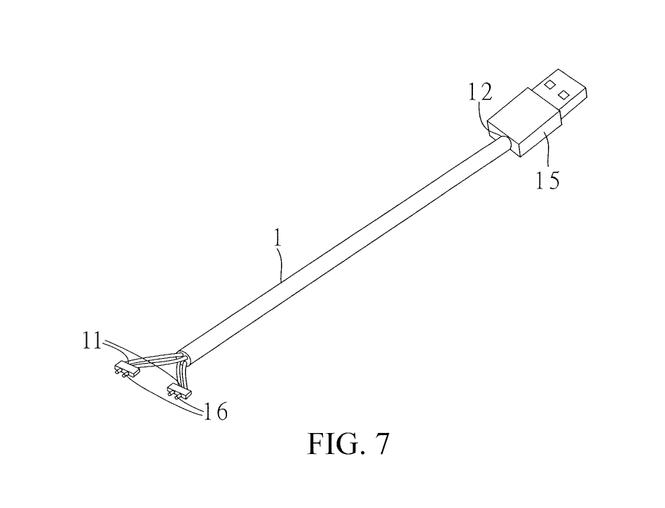

Subsequently, please referring to FIGS. 6-14, the method of manufacturing the dock in accordance with a preferred embodiment of the present invention is illustrated by the flow chart of FIG. 6 and the perspective schematic views of FIGS. 7-14.

For purposes of brevity, any description in the aforementioned Embodiment is incorporated herein insofar as the same is applicable, and the same description need not be repeated.

FIG. 7 is provided to illustrate the step of providing a cable 1, corresponding to the step S110 of FIG. 6. In this illustration, the cable 1 is provided with two first terminal blocks 16 at its first end 11 and a connector 15 at its second end 12.

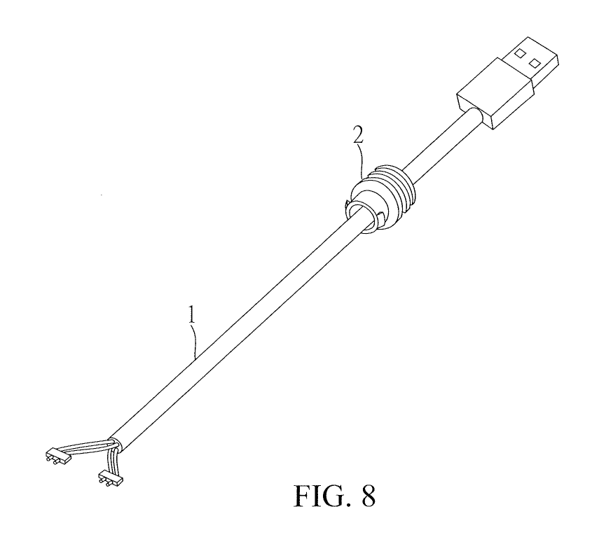

Reference is next made to FIG. 8 in conjunction with the step S120 of FIG. 6 for illustrating the step of disposing a collar 2 between the first end 11 and the second end 12 of the cable 1. As the connector 15 at the second end 12 of the cable 1 cannot pass through the first through hole 21, the passage of the cable 1 through the first through hole 21 of the collar 2 is achieved by guiding the first end 11 of the cable 1 through the first through hole 21 of the collar 2. The description “disposing a collar 2 between the first end 11 and the second end 12 of the cable 1” for the step illustrated in FIG. 8 refers to that the location of the collar 2 is between the first end 11 and the second end 12 and can be adjusted in the subsequent step according to the requirement, and does not refer to immovable installation of collar 2 on the cable 1.

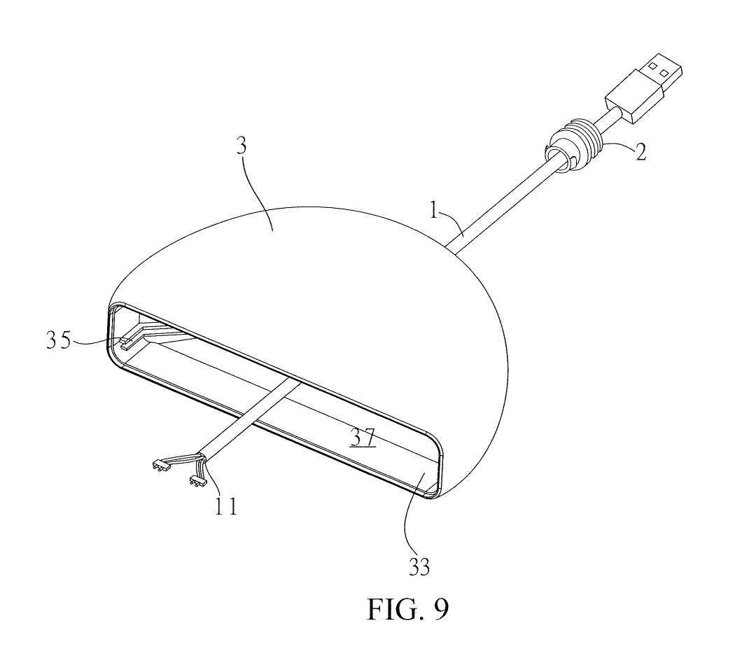

Now turning to FIG. 9 in conjunction with the step S130 of FIG. 6, the first end 11 of the cable 1 is guided through the second through hole 34 and the opening 33 of the housing 3 for disposing the housing 3 between the collar 2 and the first end 11 of the cable 1. The description “disposing the housing 3 between the collar 2 and the first end 11 of the cable 1” for the step illustrated in FIG. 9 refers to that the location of the housing 3 is between the collar 2 and the first end 11 of the cable 1 and can be adjusted in the subsequent step according to the requirement, and does not refer to immovable installation of housing 3 on the cable 1.

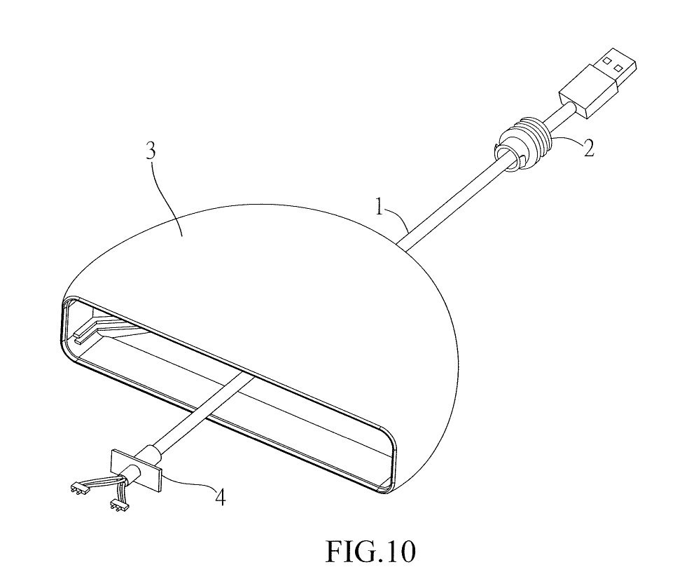

After the step S130 of disposing the housing 3 on the cable 1, the step S140 of FIG. 6 is performed to dispose a strain relief sleeve 4 on the cable 1, as shown in FIG. 10. The strain relief sleeve 4 is fixed on the cable 1 and located between the housing 3 and the first end 11 of the cable 1 to be adjacent to the first terminal blocks 16. For instance, the strain relief sleeve 4 can be directly formed around the peripheral edge of the cable 1 and secured to the cable 1 by molding. More specifically, after the step of FIG. 9, a portion of the cable 1 near the first end 11 can be placed in a mold, followed by an injection process to form the strain relief sleeve 4 at the location in close proximity to the first end 11 of the cable 1. In this case, the strain relief sleeve 4 is immovable and fixed on the cable 1. However, the step of disposing the strain relief sleeve 4 on the cable 1 is not limited to the aforementioned molding process. As an alternative, two half strain relief sleeves 4 may be first formed by, for example, bisecting the complete strain relief sleeve 4, and then the two half strain relief sleeves 4 are disposed around the cable 1 and fused with each other to form an integrated one.

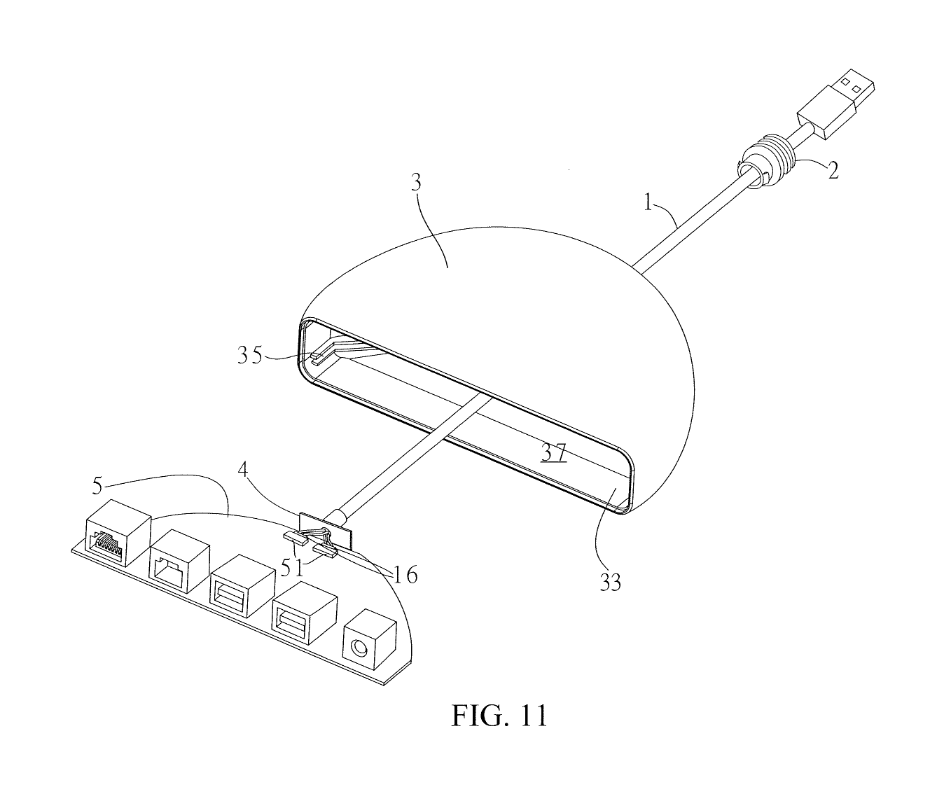

Subsequently, as shown in FIG. 11, the step S150 of FIG. 6 is performed after the step S140 of disposing the strain relief sleeve 4 on the cable 1. The first terminal blocks 16 are plugged in the second terminal blocks 51 of the circuit board 5 to electrically connect the cable 1 to the circuit board 5. In other words, the first terminal blocks 16 and the second terminal blocks 51 are brought into plug-and-socket connection with each other. Additionally, it is also feasible to omit the first terminal blocks 16 and the second terminal blocks 51 and to directly solder the conducting wires 13 at the first end 11 of the cable 1 to the circuit board 5.

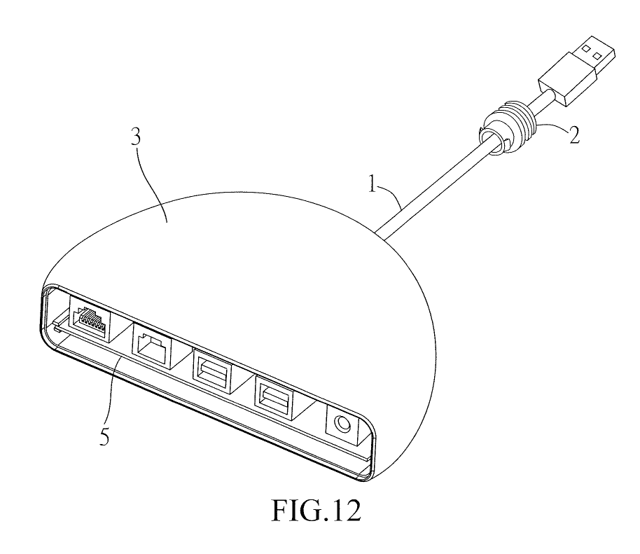

Directing attention to FIG. 12 in conjunction with the step S160 of FIG. 6, the cable 1 is pulled and moved with respect to the housing 3. With the movement of the cable 1, the strain relief sleeve 4 and the circuit board 5 are also moved with respect to the housing 3 due to the strain relief sleeve 4 being fixed on the cable 1 and the circuit board 5 being electrically connected to the cable 1. As a result, the circuit board 5 and the strain relief sleeve 4 can pass through the opening 33 of the housing 3 and be placed into the containing space 37, with the two lateral sides of the circuit board 5 being inserted into the two guide rails 35 of the housing 3. As the pad 42 of the strain relief sleeve 4 has a lager dimension than the second through hole 34 of the housing 3, the pad 42 can abut against the inner surface 31 of the housing 3, without pulling the strain relief sleeve 4 out of the housing 3 through the second through hole 34, after the above pulling step. Accordingly, this approach can avoid detaching between the first terminal blocks 16 and the second terminal blocks 51 caused by excessive drag on the cable 1.

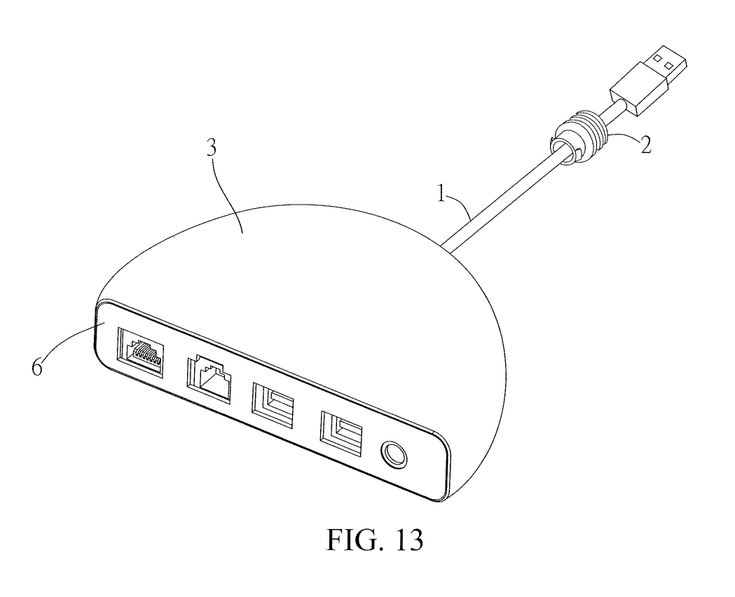

Reference is now made to FIG. 13 in conjunction with the step S170 of FIG. 6 for illustrating that a cover plate 6 covers the opening 33 of the housing 3 and is bonded to the housing 3, thereby sealing the opening 33. As a result, the first end 11 of the cable 1, the strain relief sleeve 4 and the circuit board 5 are enclosed in the containing space 37 by the housing 3. The bonding between the cover plate 6 and the housing 3 can be achieved by ultrasonic welding, but is not limited thereto.

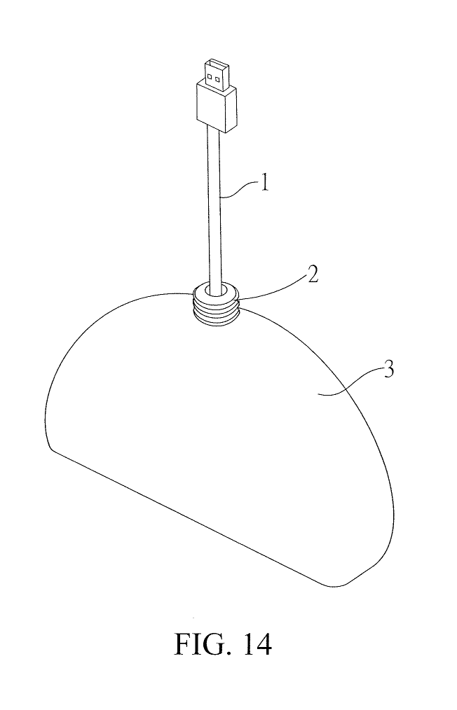

After the step S170 of bonding the cover plate 6 to the housing 3, the collar 2 is moved toward the first end 11 of the cable 1, as shown in FIG. 14 corresponding to the step S180 of FIG. 6. The fitting structures 24 of the collar 2 are embedded into and then pass through the guide grooves 36 of the housing 3, followed by screwing the collar 2 until the second annular section 23 of the collar 2 is tightened in the second through opening 34. Accordingly, the collar 2 is bonded to the housing 3, and the second through hole 34 of the housing 3 is sealed. At this stage, the dock 1000 of the present invention is accomplished.

In accordance with this embodiment, the step S180 of bonding the collar 2 to the housing 3 is performed after the step S160 of pulling the cable 1 and the step S170 of bonding the cover plate 6 to the housing 3. However, in other embodiments of the present invention, the desired result also can be achieved by first carrying out the step S180 of bonding the collar 2 to the housing 3 and then the step S 160 of pulling the cable 1 and the step S170 of bonding the cover plate 6 to the housing 3.

For the dock accomplished by the aforementioned assembly process, when a force is applied to the cable 1 in the direction from the first end 11 to the second end 12, the applied force would impose stress on the contact regions between the pad 42 of the strain relief sleeve 4 and the inner surface 31 of the housing 3 rather than the electrical joints (e.g. plug-and-socket joints between the terminal blocks or solder joints) between the cable 1 and the circuit board 5 owing to the strain relief sleeve 4 being fixed on the cable 1 and the pad 42 of the strain relief sleeve 4 having a dimension larger than that of the second through hole 34 of the housing 3 and being pressed against the inner surface 31 of the housing 3. On the contrary, when applying a force to the cable 1 in the direction from the second end 12 to the first end 11, as the resistance is provided by the configuration of the collar 2 tightly clamping the cable 1 and the circuit board 5 being blocked by the cover plate 6, the cable 1 can be maintained stationary under the applied force, thereby avoiding any crack or detaching of the electrical joints between the cable 1 and the circuit board 5 caused by dragging or compressing the cable 1. Furthermore, the guide rails 35 also provide holding effect for the circuit board 5 so as to prevent severe skew during the assembly process.

The embodiments described herein are exemplary and the description may simplify or omit elements or steps well-known to those skilled in the art to prevent obscuring the present invention. Likewise, the drawings may omit duplicative or unnecessary elements and reference labels to improve clarity.

Unless specific descriptions or steps necessarily occur in a certain order, the sequence of the above-mentioned steps is not limited to that set forth above and may be changed or reordered according to desired design.

The above examples are intended for illustrating the embodiments of the subject invention and the technical features thereof, but not for restricting the scope of protection of the subject invention. Many other possible modifications and variations can be made without departing from the spirit and scope of the invention as hereinafter claimed. The scope of the subject invention is based on the claims as appended.

What is claimed is:

1. A method of manufacturing a dock, comprising steps of:
providing a cable that includes a first end and a second end opposite to the first end;
disposing a collar on the cable;
disposing a housing on the cable and between the collar and the first end of the cable, wherein the housing includes an inner surface, an outer surface, an opening and a second through hole, the inner surface defines a containing space, the opening and the second through hole extend through the inner surface and the outer surface and communicate with the containing space, respectively, and the cable extends through the second through hole;
securing a strain relief sleeve on the cable and between the housing and the first end of the cable, wherein the strain relief sleeve includes a tube and a pad connected to each other, the pad has a third through hole and a dimension larger than the second through hole, and the cable extends through the tube and the third through hole;
electrically connecting a circuit board to the first end of the cable;
disposing the circuit board and the strain relief sleeve in the containing space from the opening of the housing;
bonding a cover plate to the housing to seal the opening of the housing; and
moving and bonding the collar to the housing.

2. The method of claim 1, wherein the step of securing the strain relief sleeve on the cable is performed by molding the strain relief sleeve on the cable.

3. The method of claim 1, wherein the strain relief sleeve further includes two lateral flanges connected to two sides of the pad, the lateral flanges each have a groove, and a step of inserting the circuit board into the grooves is further performed before the step of disposing the circuit board and the strain relief sleeve in the containing space.

4. The method of claim 1, wherein the step of moving and bonding the collar to the housing is performed before the step of disposing the circuit board and the strain relief sleeve in the containing space.

5. The method of claim 1, wherein the step of disposing the circuit board and the strain relief sleeve in the containing space is performed by pulling and moving the cable, whereby the housing moves relatively toward the first end.

6. The method of claim 4, wherein the step of disposing the circuit board and the strain relief sleeve in the containing space is performed by pulling and moving the cable, whereby the housing moves relatively toward the first end.

7. The method of claim 1, wherein the housing further includes two guide rails on the inner surface thereof, and the step of disposing the circuit board and the strain relief sleeve in the containing space is performed with the circuit board being inserted into the guide rails.

8. The method of claim 4, wherein the housing further includes two guide rails on the inner surface thereof, and the step of disposing the circuit board and the strain relief sleeve in the containing space is performed with the circuit board being inserted into the guide rails.

9. The method of claim 1, wherein the second end of the cable is provided with a connector, and the step of disposing the collar on the cable is performed by guiding the first end of the cable through a first through hole of the collar.

10. The method of claim 1, wherein the first end of the cable is provided with at least one first terminal block, the circuit board has at least one second terminal block, and the step of electrically connecting the circuit board to the first end of the cable is performed by bringing the first terminal block and the second terminal block into plug-and-socket connection with each other.

11. The method of claim 1, wherein the step of electrically connecting the circuit board to the first end of the cable is performed by soldering the first end of the cable to the circuit board.

12. The method of claim 1, wherein the collar includes a first through hole, a first annular section, a second annular section connected to the first annular section, and at least one fitting structure disposed on a peripheral edge of the second annular section, therewith the first annular section having a cross-sectional dimension larger than that of the second annular section, and the first through hole extending through the first annular section and the second annular section; the housing includes at least one guide groove at a peripheral edge of the second through hole; and the step of moving and bonding the collar to the housing includes: moving the collar toward the first end of the cable; embedding the fitting structure of the collar into the guide groove of the housing; and screwing the collar to tighten the second annular section of the collar in the second through hole of the housing after passage of the fitting structure through the guide groove.
